(19) United States
(12) Patent Application Publication
(10) Pub. No.: US 2006/0259477 A1
(43) Pub. Date: Nov. 16, 2006

(54) Image managing apparatus, image managing method, image managing program, and storage medium

(76) Inventor: Tetsu Morita, Fuchu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/430,346

(22) Filed: May 9, 2006

(30) Foreign Application Priority Data
May 10, 2005 (JP) 2005-137469

(51) Int. Cl. G06F 17/30

(52) U.S. Cl. 707/3

(57) ABSTRACT

An image managing method for making a search for, and classifying images stored in an image memory, the method includes specifying a search condition, making a search for the images stored in the image memory under the specified search condition, displaying index images of the searched images in one independent index display window, selecting a plurality of the index display windows, integrating the plurality of selected index display windows in one index display window, integrating and displaying the index images displayed respectively in the plurality of selected index display windows in the one integrated index display window, and registering as one group all images corresponding to the index images integrated in the one integrated index display window.

### CROSS-REFERENCE TO RELATED APPLICATIONS

This application is based upon and claims the benefit of priority from prior Japanese Patent Application No. 2005-137469, filed May 10, 2005, the entire contents of which are incorporated herein by reference.

### BACKGROUND OF THE INVENTION

1. Field of the Invention

The present invention relates to an image management technology for displaying and managing images.

2. Description of the Related Art

In recent years, electronic devices such as computers equipped with a high-capacity storage medium have been prevalent, and concurrently, the number of images stored in a storage medium has significantly increased. Thus, there is a need for a method capable of making a search for a desired group of images from the stored groups of images with good operability.

A technique disclosed in, for example, Jpn. Pat. Appln. KOKAI Publication No. 11-96194 is known as a method of efficiently making a search for images. When, in this method, a folder displayed in a folder display region is selected on a browser screen, the selected folder is identified and displayed, and thumbnails of an image file contained in the selected folder are displayed in a thumbnail display region.

### BRIEF SUMMARY OF THE INVENTION

According to a first aspect of the present invention, there is provided an image managing apparatus which searches and classifies images, the apparatus comprising: an image memory which stores images; a condition specifying unit which specifies at least one search condition; a search unit which makes a search for images stored in the image memory under the search condition specified by the condition specifying unit; a search result display unit which displays index images of the images searched by the search unit on one independent index display window; a window selector unit which selects a plurality of displayed index display windows; a window integrating unit which integrates the plurality of index display windows selected by the window selector unit into one index display window; an index integrating unit which integrates and displays the index images displayed respectively in the plurality of selected index display windows in the one index display window integrated by the window integrating unit; and a register unit which registers as one group, all images corresponding to the index images integrated into the one index display window by the index integrating unit.

According to a second aspect of the present invention, there is provided an image managing method for making a search for, and classifying images stored in an image memory, the method comprising: a condition specifying step of specifying a search condition; a search step of making a search for the images stored in the image memory under the search condition specified in the condition specifying step; a search result display step of displaying index images of the images searched in the search step in one independent index display window; a window selecting step of selecting a plurality of index display windows; a window integrating step of integrating the plurality of index display windows selected in the window selecting step in one index display window; an index integrating step of integrating and displaying the index images displayed respectively in the plurality of selected index display windows in the one index display window integrated in the window integrating step; and a grouping step of registering as one group all images corresponding to the index images integrated in the one index display window in the index integrating step.

According to a third aspect of the present invention, there is provided an image managing program for making a search for, and classifying images stored in an image memory, the program causing a computer to execute a process of: specifying a search condition; making a search for the images stored in the image memory under the specified search condition; displaying index images of the searched images in one independent index display window; selecting a plurality of the index display windows; integrating the plurality of selected index display windows in one index display window; integrating and displaying the index images displayed respectively in the plurality of selected index display windows in the one integrated index display window; and registering as one group all images corresponding the index images displayed in the one integrated index display window.

According to a fourth aspect of the present invention, there is provided a storage medium having recorded therein an image managing program for making a search for, and classifying images stored in an image memory, the program causing a computer to execute: a condition specifying step of specifying a search condition; a search step of making a search for the images stored in the image memory under the search condition specified in the condition specifying step; a search result display step of displaying index images of the images searched in the search step in one independent index display window; a window selecting step of selecting a plurality of index display windows; a window integrating step of integrating the plurality of index display windows selected in the window selecting step in one index display window; an index integrating step of integrating and displaying the index images displayed respectively in the plurality of selected index display windows in the one index display window integrated in the window integrating step; and a grouping step of registering as one group all images corresponding to the index images integrated in the one index display window in the index integrating step.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an image management screen in accordance with an image managing method according to a first embodiment of the present invention;

FIG. 2 is a view illustrating an operation of displaying a window based on a specified period;

FIG. 3 is a view illustrating an operation of displaying a window based on a specified photographing parameter;

FIG. 4 is a view illustrating an operation of displaying a window based on a specified keyword;

FIG. 5A is a view showing an index display window before integrated;

FIG. 5B is a view showing an index display window after integrated;

FIG. 6 is a view showing a group storage dialog;

FIG. 7 is a view showing a group display dialog;

FIG. 8 is a view showing a keyword register dialog;

FIG. 9 is a view illustrating a method of displaying an associated index image based on an arbitrary image;

FIG. 10 is a view showing a popup menu;

FIG. 11 is a diagram showing a configuration of an image managing apparatus;

FIG. 12 is a view showing the contents of image management information;

FIG. 13 is a view showing the contents of keyword data;

FIG. 14 is a view showing the contents group data;

FIG. 15 is a view showing the contents of parameter data for photographing;

FIG. 16 is a flow chart showing brief procedures for carrying out an image management process;

FIG. 17 is a flow chart showing procedures for carrying out a display process;

FIG. 18 is a flow chart showing procedures for carrying out a keyword registration process;

FIG. 19 is a flow chart showing procedures for carrying out a group display process;

FIG. 20 is a flow chart showing procedures for carrying out a group storage process;

FIG. 21 is a flow chart showing procedures for carrying out a window integration process;

FIG. 22 is a flow chart showing procedures for carrying out a window integration process;

FIG. 23 is a flow chart showing procedures for carrying out a tree display update process;

FIG. 24 is a flow chart showing procedures for carrying out processes of year, month and day buttons;

FIG. 25 is a flow chart showing procedures for carrying out an associated search and display process;

FIG. 26 is a flow chart showing procedures for carrying out a capture process; and

FIG. 27 is a flow chart showing procedures for carrying out a window close process.

### DETAILED DESCRIPTION OF THE INVENTION

### First Embodiment

In an image managing method according to an embodiment of the present invention, a user executes an image management and search operation based on an image management screen displayed on a display unit of an image managing apparatus.

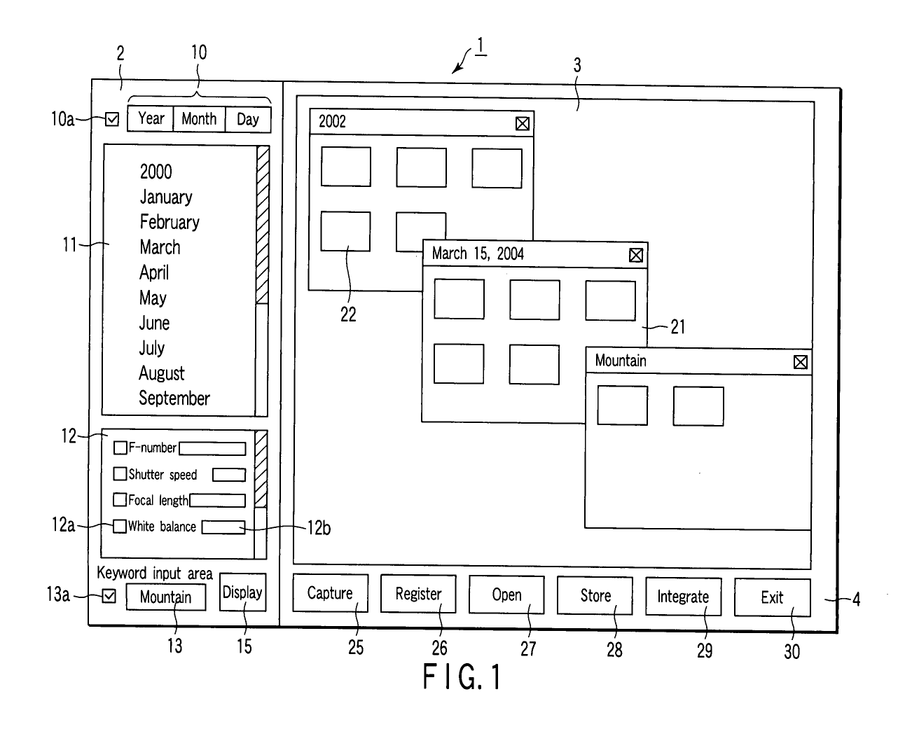

FIG. 1 is a view showing a configuration of an image management screen in accordance with an image managing method according to a first embodiment of the present invention.

A search condition input area 2, a window display area 3, and an operation input area 4 are provided on an image management screen 1.

The search condition input area 2 includes a period determining button 10, a search target checkbox 10a, a time series tree display area 11, a photographing parameter setting area 12, a keyword input area 13, a search target checkbox 13a, and a display button 15.

The period determining button 10 consists of “year”, “month”, and “day” buttons, and a search period can be specified in units of years, months, and days. In the time series display area 11, a selection period icon is displayed in response to an operation of the period determining button 10. When a search is made by using these periods, there is a need for the search target checkbox 10a to have been checked.

A search target checkbox 12a and a photographing parameter input field 12b are provided in the photographing parameter setting area 12 together with photographing parameters. A user specifies a value in the photographing parameter input field 12b with respect to a desired photographing parameter, and checks the search target checkbox 12a, thereby making a search by using the photographing parameter.

A keyword to be searched is inputted in the keyword input area 13. When a keyword is used for a search condition, there is a need for the search target checkbox 13a to have been checked. The display button 15 is provided as an operating button for specifying execution of search.

A search result is displayed in the window display area 3. In FIG. 1, a plurality of index display windows 21 are displayed, and index images 22 are displayed in each of the index display windows 21.

A capture button 25, a register button 26, an open button 27, a store button 28, an integrate button 29, and an exit button 30 are provided in the operation input area 4. By operating these buttons, an image can be managed, and an image display method can be changed.

Subsequently, a description will be given with respect to an input operation in the search condition input area 2 and a display operation in the window display area 3.

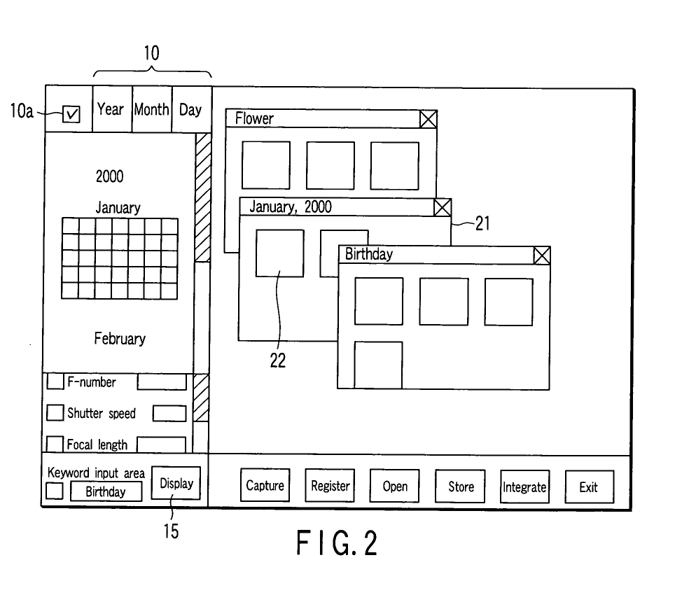

FIG. 2 is a view illustrating an operation of displaying a window based on a specified period.

When the period determining button 10 is operated while the search target checkbox 10a is checked, a selection period icon is displayed in the time series tree display area 11 in response to each of the pressed “year”, “month”, and “day” buttons.

When the “year” button is pressed, a period icon column representing years such as “2000, 2001, . . . ” is displayed. When the “month” button is pressed, a period icon column representing months such as “January, February, March, . . . ” is displayed in the lower layer of a period icon representing a year. When the “day” button is pressed, a calendar in which days have been allocated is displayed in the lower layer of a period icon representing a month.

A user can select a desired “year”, “month” and “day” from the period icon displayed in the time series tree display area 11. When the user selects a period icon and presses the display button 15 while the search target checkbox 10a is checked, an index display window 21 corresponding to each of the selected “year”, “month” and “day” is opened. Then, index images 22 of images photographed on the selected “year”, “month” and “day” are displayed in the index display window 21.

When the user repeats selections of “year”, “month” and “day”, a plurality of index display windows 21 are displayed in the window display area 3. In the case where the user has selected “2000”, and “January, 2000” as period icons, the same index images 22 are displayed to be included in the plurality of index display windows 21. Then, when the user clicks an X button that exists at the top right of the index display window 21, the index display window 2 is cleared.

Period icons are displayed in a tree format. By clicking a hierarchical display icon representing a tree structure, for example, a +− icon, a display of the lower layer can be made or a display of the lower layer can be cleared.

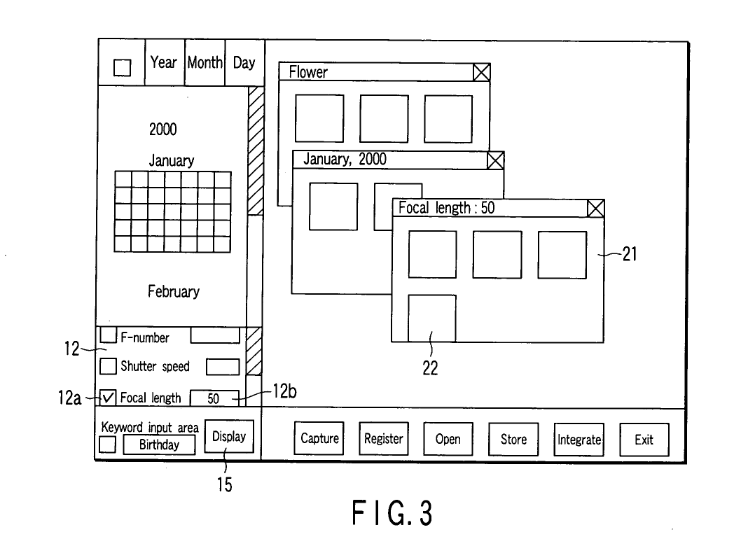

FIG. 3 is a view illustrating an operation of displaying a window based on a specific photographing parameter.

With respect to an item checked in the search target checkbox 12a, its value is set in the photographing parameter input field 12b, and the display button 15 is pressed. Consequently, an index display window 21 corresponding to the selected photographing parameter is opened in the window display area 3. Then, index images 22 of images photographed based on the set value are displayed in the index display window 21. In the case where a plurality of photographing parameters are selected, images having all the conditions are selected.

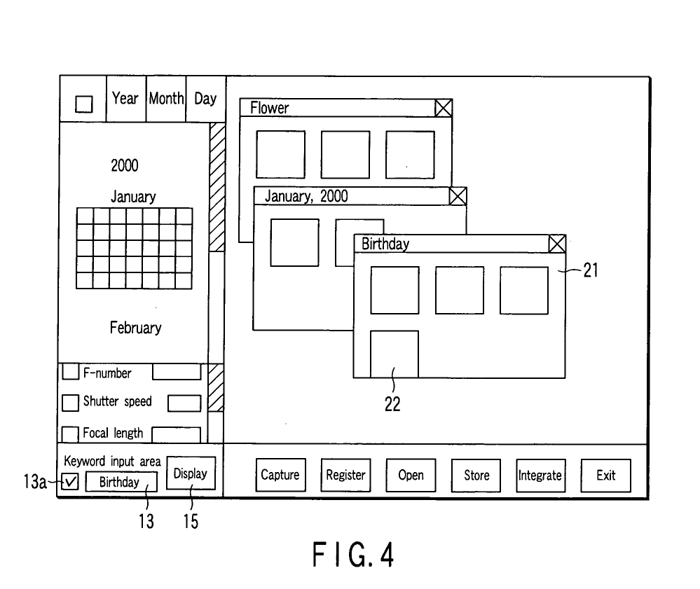

FIG. 4 is a view illustrating an operation of displaying a window based on a specified keyword.

When a keyword is inputted in the keyword input area 13 and the display button 15 is pressed while the search target checkbox 13a is checked, an index display window 21 corresponding to the inputted keyword is opened in the window display area 3. Then, index images 22 of images having the inputted keyword assigned thereto are displayed in the index display window 21. In the case where a plurality of keywords are inputted, images having all the keywords are selected. In addition, in the case where a plurality of keywords are assigned to images, the same index images 22 are displayed in different index display windows 21.

With respect to the period, photographing parameters, keywords described above, a plurality of conditions can be specified at one time by properly combining them. In this case, these conditions can be specified by checking the search target checkboxes 10a, 12a and 13a to be specified for the conditions. For example, a search can be made for an image photographed in the year of “2004” and under a condition of “focus distance of 50 mm”, the image having a “birthday” specified as a keyword.

Now, a description will be given with respect to an input operation in the operation input area 4 and a display operation in the window display area 3.

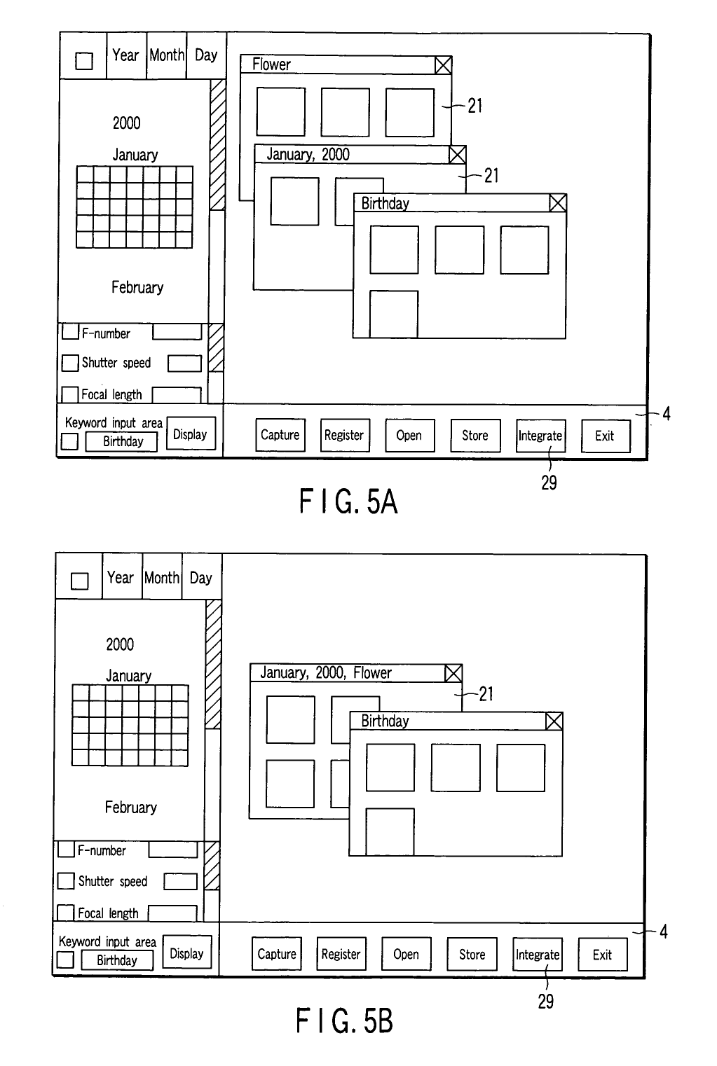

FIGS. 5A and 5B are views illustrating a processing of integrating index display windows.

FIG. 5A shows a state before integrated. A user select a plurality of index display windows 21 displayed in the window display area 3. For example, the user selects index display windows 21 specified by keywords “flower” and “January, 2000”. Then, when the integrate button 29 is pressed, one index display window 21 having two index display windows 21 integrated therewith is generated, as shown in FIG. 5B. The new index display window 21 includes respective index displays 22. Then, the index display windows 21 before integrated are cleared. Even when the same index images 22 are included in the two index display windows 21 before integrated, no duplicate index images 22 are displayed in the index display window 21 after integrated.

Integration of the index display windows can also be executed by a drag & drop operation. When an index display window 21 specified by a keyword “flower” is dragged & dropped on an index display window 21 specified by a keyword “January 2000”, an index display window 21 specified by a keyword “January 2000, flower” is newly generated while respective index images 22 are added. Then, the index display windows 21 before dragged & dropped are cleared.

The above-described integrating operation can be repeatedly executed. In addition, the integrated index display window 21 and another index display window 21 can be further integrated.

In the above-described integration example, the index images 22 included in the two index display windows 21 are collected. That is, the collected index images correspond to the images which are searched and obtained in accordance with a union of search conditions specified when a search is made for the images corresponding to the index images included in each index display window 21. On the other hand, in accordance with an intersection of search conditions, common index images which are included in two index display windows 21 may be displayed in the integrated index display windows 21.

Next, a description will be given with respect to a method of registering a plurality of index display windows 21 in one group.

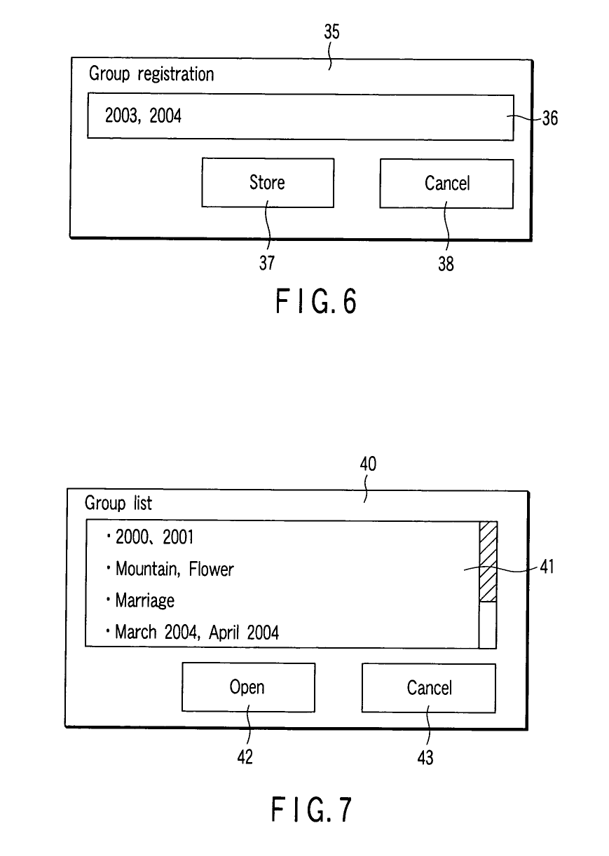

A user selects a plurality of index display windows 21 displayed in the window display area 3. Then, when the user presses the store button 28, a group storage dialog 35 shown in FIG. 6 is displayed.

The group storage dialog 35 is provided with an input area 36 for registering a group name, a store button 37, and a cancel button 38. In the input area 36, a title of a selected index display window 21 is displayed as a group name.

Then, when the user additionally inputs a title of an index display window 21 whose group name is to be added in the input area 36, and presses the store button 37, the index display window 21 displayed in the input area 36 is registered and stored as the same group. After this registration/storage processing, the user can open the index display window 21 by specifying a group name. The user can also specify a group name to which an index image 22 belongs by specifying the index image 22.

When the user presses the cancel button 38, the group storage dialog 35 is cleared.

In the case where the integration of the index display windows 21 described above have been carried out, the index display windows 21 after integrated may be registered as one group.

Now, a description will be given with respect to a method of displaying a plurality of index display windows 21 that belong to an arbitrary group.

When a user presses the open button 27, a group display dialog 40 shown in FIG. 7 is displayed.

The group display dialog 40 is provided with a selection area 41 for selecting a group, an open button 42, and a cancel button 43. Names of the registered groups are displayed in the selection area 41.

When the user selects a group name of the selection area 41 and presses the open button 42, an index display window 21 belonging to the group is displayed in the window display area 3.

When the user presses the cancel button 43, the group display dialog 40 is cleared.

Next, a method of assigning a keyword to an image will be described here.

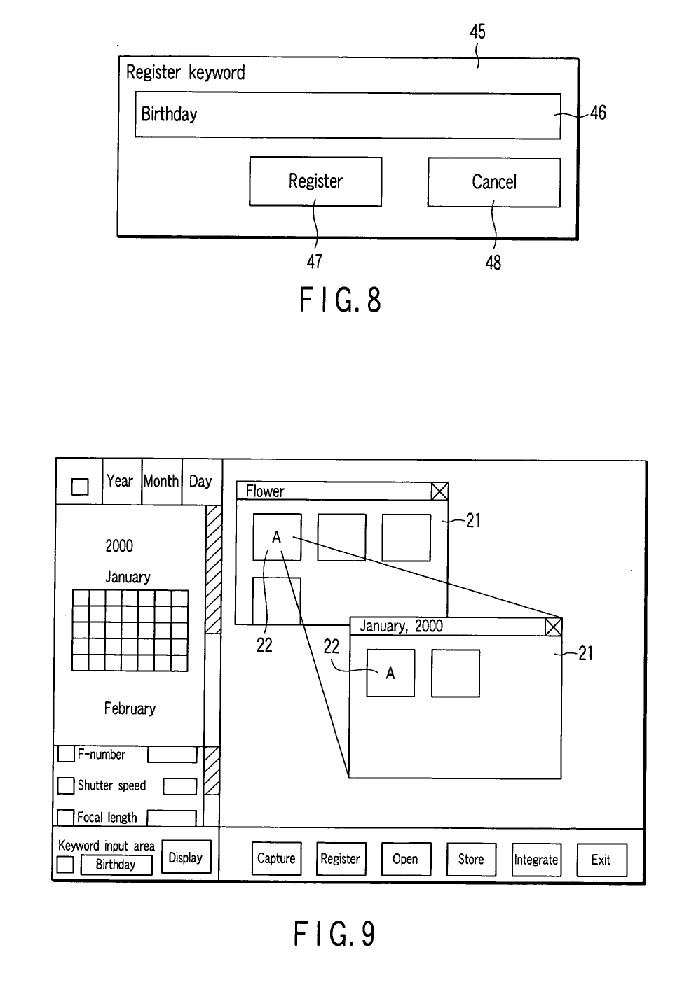

When a user selects an index display window 21 or an index image 22, and presses the register button 26, a keyword register dialog 45 shown in FIG. 8 is displayed.

The keyword register dialog 45 is provided with an input area 46 for inputting a keyword, a register button 47, and a cancel button 48.

When the user inputs a keyword in the input area 46, and presses the register button 47, the inputted keyword is additionally assigned to an image that corresponds to the selected index image 22. In addition, when index display windows 21 are selected, keywords are additionally assigned to images that correspond to all the index images 22 included in the selected index display windows 21.

Further, when the user presses the cancel button 48, the keyword register dialog 45 is cleared.

Now, with reference to FIG. 9, a description will be given with respect to a method of displaying an associated index image based on an arbitrary image.

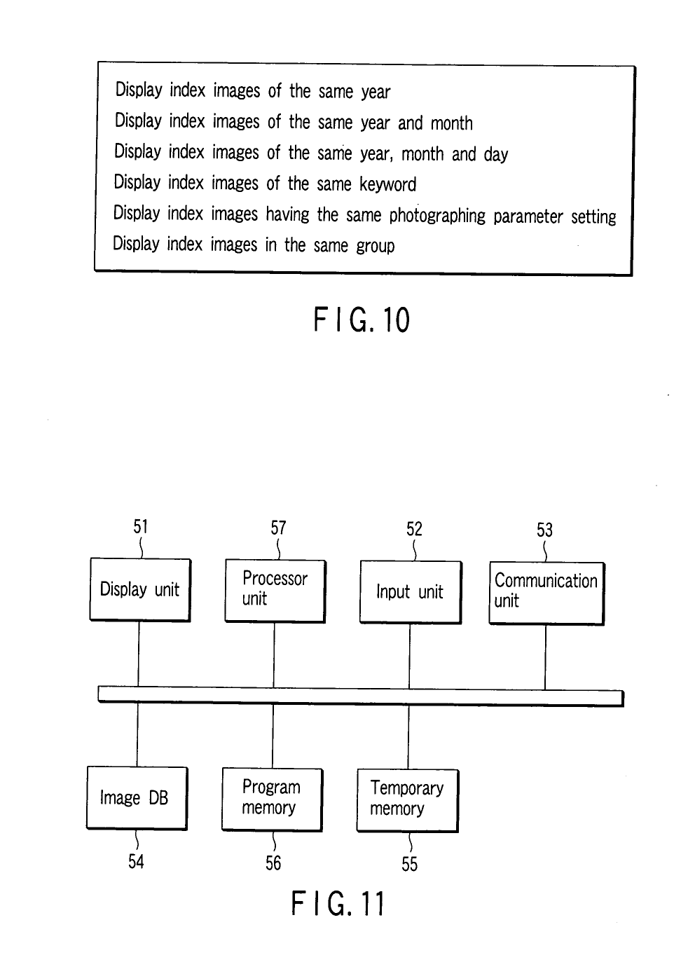

When a user moves a mouse pointer onto an index image 22 displayed in an index display window 21, and then, clicks a right mouse button, a popup menu shown in FIG. 10 is displayed. When the user select an arbitrary item from the menu, a new index display window 21 is displayed, and an index image corresponding to the selected item from the menu is displayed.

For example, assume that Date information on an index image 22 existing in an index display window 21 specified by a keyword “flower” shown in FIG. 9 is Feb. 10, 2001.

When the user selects an item “display index images of the same year” from the popup menu, index images of images whose date information is 2000 are displayed.

When the user selects an item “display index images of the same year and month” from the popup menu, index images of images whose date information is February 2001 are displayed.

When the user selects an item “display index images of the same year, month and day” from the popup menu, index images of images whose date information is Feb. 10, 2001 are displayed.

When the user selects an item “display index images of the same keyword” from the popup menu, index images of images having a keyword identical to the keyword assigned in association with the selected index image are displayed.

When the user selects an item “display index images having the same photographing parameter setting”, the index images are displayed as objects checked in the search target checkbox 12a of the photographing parameter setting area 12. Then, index images having the same values are displayed with respect to the target photographing parameters.

When the user selects an item “display index images of the same group”, a group name to which the selected index image belongs is specified. Then, all the index images belonging to the group are displayed.

Subsequently, a description will be given with respect to a configuration of an image managing apparatus for achieving the above-described image managing method and operating procedures for achieving the managing method.

FIG. 11 is a diagram showing a configuration of an image managing apparatus 50. The image managing apparatus 50 comprises a display unit 51, an input unit 52, a communication unit 53, an image database (DB) 54, a temporary memory 55, a program memory 56, and a processor unit 57.

The display unit 51 is a CRT or TFT liquid crystal display for displaying an image management screen. The input unit 52 is an input device such as a keyboard or a mouse for receiving an operating command input from a user.

The communication unit 53 is an interface for exchanging information such as an image file with an external device (not shown) such as, for example, a digital camera by means of communication. The image DB 54 is a storage medium for storing image data and image management information. The temporary memory 55 is a buffer memory for temporarily storing information required for image management processing. The program memory 56 stores programs for controlling functions of the image managing apparatus 50. The processor unit 57 integrally controls an operation of the image managing apparatus 50.

Now, image management information will be described here.

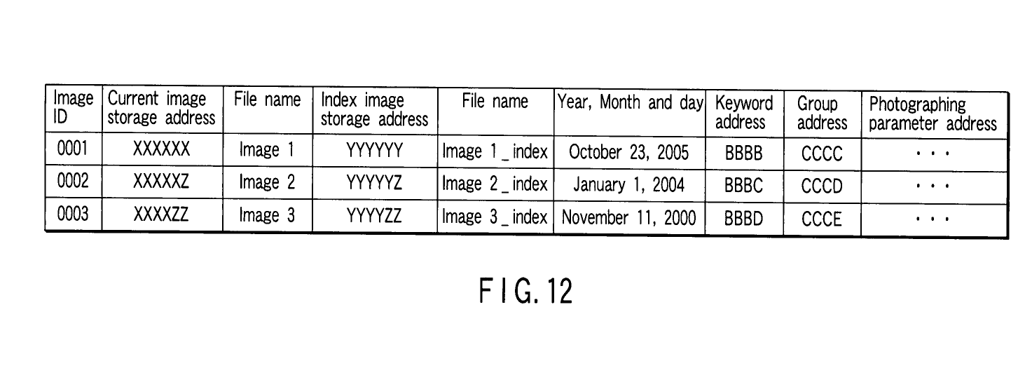

FIG. 12 is a view showing the contents of image management information.

With respect to the image management information, a “source image storage address” and a “file name” are described as information relating to a source image. In addition, an “index image storage address” and a “file name” are described as information relating to an index image. Further, a “photographing year, month and day” a “keyword address”, a “group address” and a photographing parameter address” are described as information for making a search. Here, the “keyword address denotes a storage address of keyword data, the “group address” denotes a storage address of group data, and “the photographing parameter address” denotes a storage address of photographing parameter data.

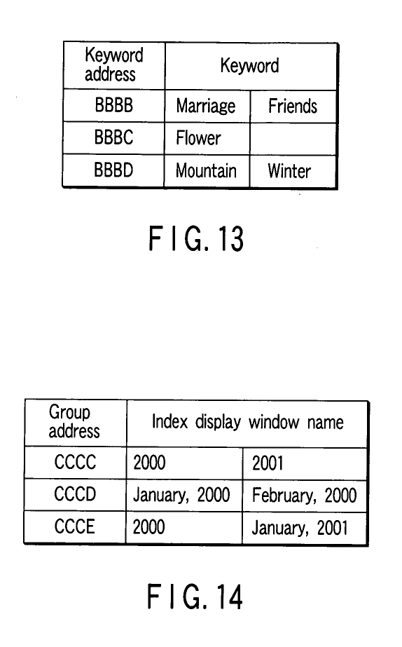

FIG. 13 is a view showing the contents of keyword data.

At a position corresponding to the “keyword address” of image management information, a keyword assigned to its image is stored. A plurality of keywords can be stored. When a new keyword is registered, the keyword is stored to be added to the existing keyword.

FIG. 14 is a view showing the contents of group data.

At a position corresponding to the “group address” of image management information, a name of an index display window belongs to its group is stored.

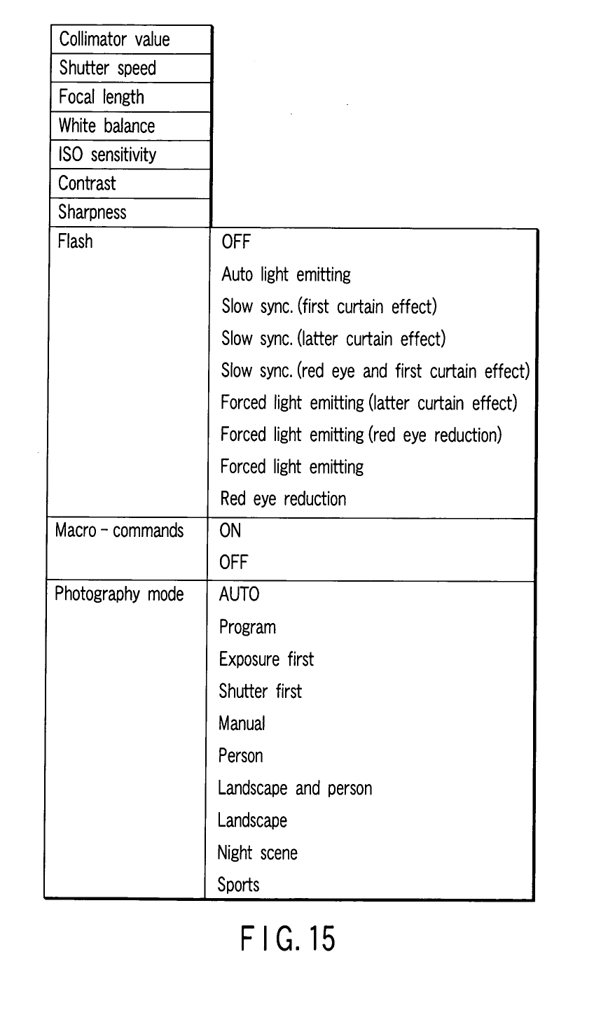

FIG. 15 is a view showing the contents of photographing parameter data.

At a position corresponding to the “photographing parameter address” of image management information, a photography condition set when that image has photographed is described.

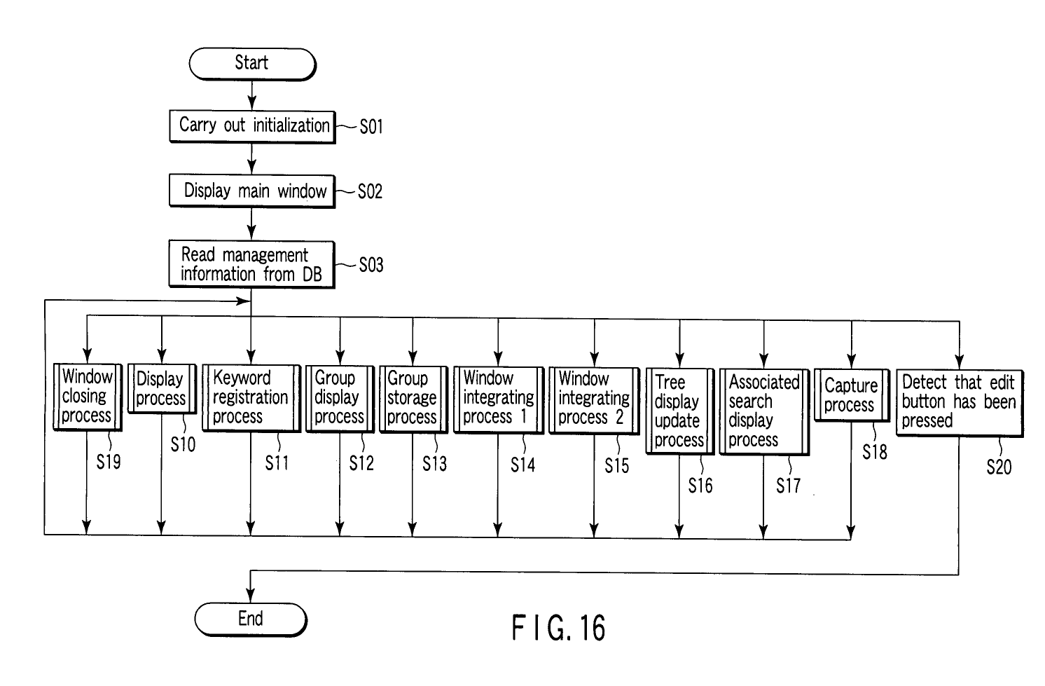

Now, with reference to FIGS. 16 to 27, a description will be given with respect to brief procedures for carrying out an image management processing in order to achieve the above-described image managing method. The processing described below is directed to a processing relating to main functions from among image management processing functions. Therefore, even in the case of a function which is not given in the following description, the functions given in the descriptions of FIGS. 1 to 15 are included in this image management processing function.

When the image managing apparatus 50 starts up, the processor unit 57 initializes a table or the like inside the apparatus in step S01 shown in FIG. 16. Then, when a user enter a command for displaying the image management screen 1 from the input unit 52, the image management screen 1 is displayed on the display unit 51, and image management information is read from the image DB 54 in steps S02 and S03. Then, the apparatus waits for a next user's operation and input.

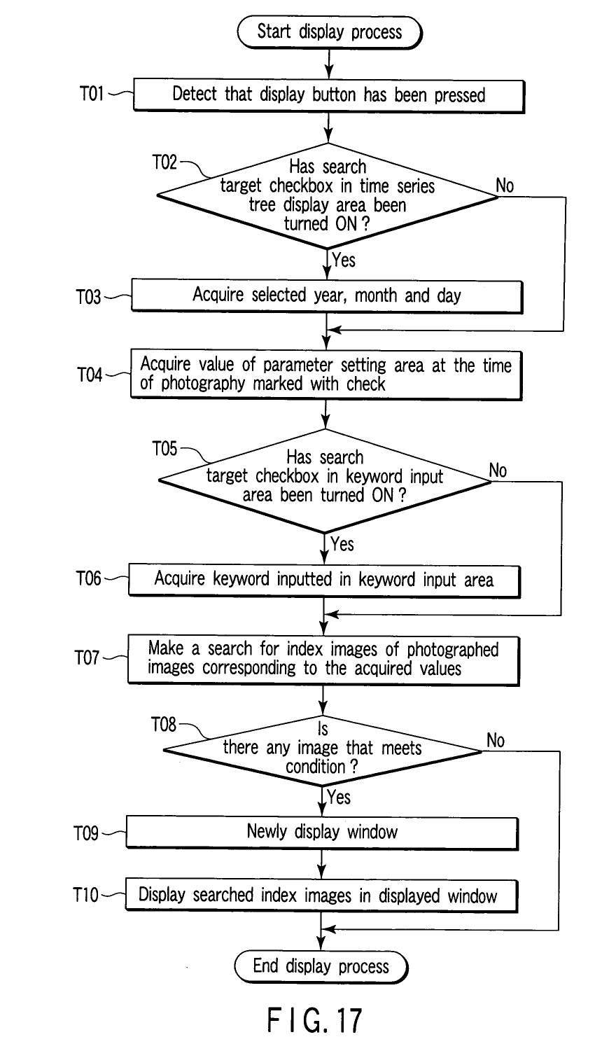

When the user presses the display button 15, a display processing shown in FIG. 17 is executed in step S10.

When the processor unit 57 detects that the display button 15 has been pressed in step T01 shown in FIG. 17, the processor unit 57 checks which one of the search target checkboxes has been checked.

In the case of Yes in step T02, i.e., when the search target checkbox 10a relating to time series tree display has been checked, a period icon selected from the time series tree display area 11 is acquired in step T03.

Next, in step T04, a photographing parameter whose search target checkbox 12a has been checked is acquired in the photographing parameter setting area 12.

In the case of Yes in step T05, i.e., when the search target checkbox 13a has been checked, a keyword inputted in the keyword input area 13 is acquired in step T06.

Subsequently, in step T07, a search is made for image management information contained in the image DB 54, and it is checked whether or not there exists an image corresponding all of the acquired values. Then, in the case of Yes in step T08, i.e., when a search has been made for the corresponding image, a new index display window 21 is displayed, and index images 22 of the searched images in the displayed window is displayed in steps T09 and T10.

Then, the display processing is terminated. Turning to FIG. 16, the apparatus waits for a user's new operation and input.

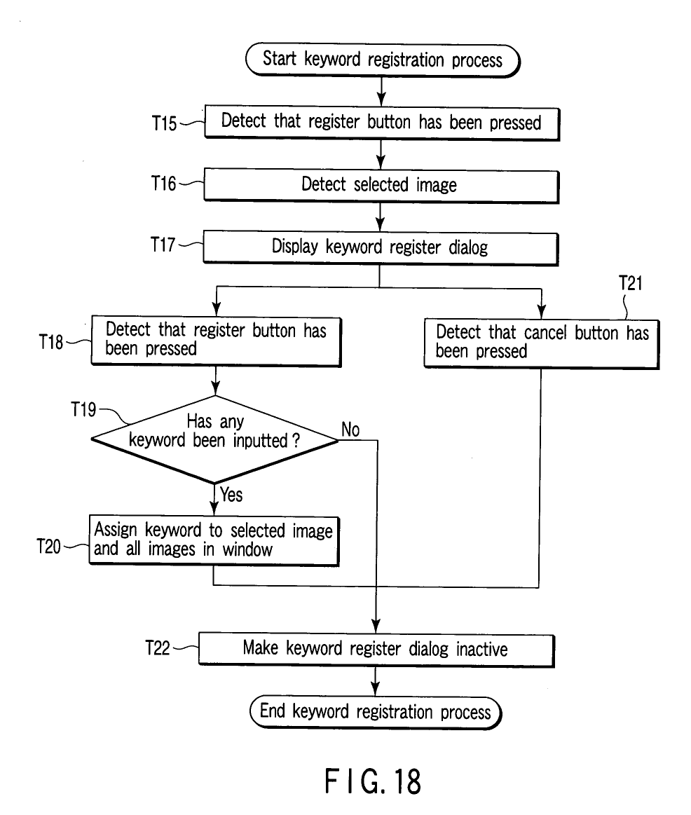

When the user presses the register button 26, a keyword registration processing shown in FIG. 18 is executed in step S11.

When the processor unit 57 detects that the register button 26 has been pressed in step T15 shown in FIG. 18, the processor unit 57 specifies a selected image in step T16. Then, in step T17, the keyword register dialog 45 is displayed, and the apparatus waits until the user has inputted a keyword.

When the user presses the register button 47, the processor unit 57 detects that the register button 47 has been pressed in step T18, and checks whether or not a keyword has been inputted in the keyword input area 46 in step T19.

In the case of Yes in step T19, i.e., in the case where a keyword has been inputted, this keyword is assigned to a selected image or all the images contained in the selected index display window 21 in step T20. Then, the keyword register dialog 45 is cleared in step T22.

On the other hand, in the case of No in step T19, i.e., in the case where no keyword is inputted, or alternatively, when the processor unit 57 detects that the cancel button 48 has been pressed in step T21, the keyword register dialog 45 is cleared in step T22.

The keyword registration processing is then terminated. Turning to FIG. 16, the apparatus waits for a user's new operation and input.

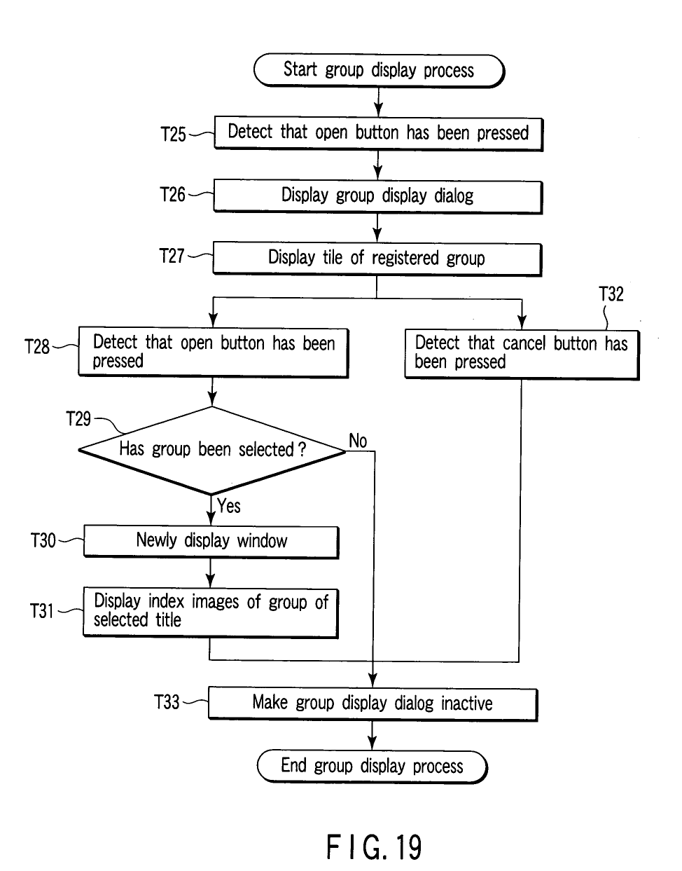

When the user presses the open button 27, a group display processing shown in FIG. 19 is executed in step S12.

When the processor unit 57 detects that the open button 27 has been pressed in step T25 shown in FIG. 19, the processor unit 57 displays the group display dialog 40 in step T26, and displays a title of a group registered in the selection area 41 in step T27. The apparatus then waits until the user has selected a group.

When the user presses the open button 42, the processor unit 57 detects that the open button 42 has been pressed in step T28, and checks whether or not a group name in the selection area 41 has been selected in step T29.

In the case of Yes in step T29, i.e., in the case where a group name has been selected, an index display window 21 is newly displayed, and index images 22 belonging to the selected group are displayed in steps T30 and T31. Then, the group display dialog 40 is cleared in step T33.

On the other hand, in the case of No in step T29, i.e., in the case where a group name is not selected, or alternatively, when the processor unit 57 detects that the cancel button 43 has been pressed in step T32, the group display dialog 40 is cleared in step T33.

Then, the group display processing is terminated. Turning to FIG. 16, the apparatus waits for a user's new operation and input.

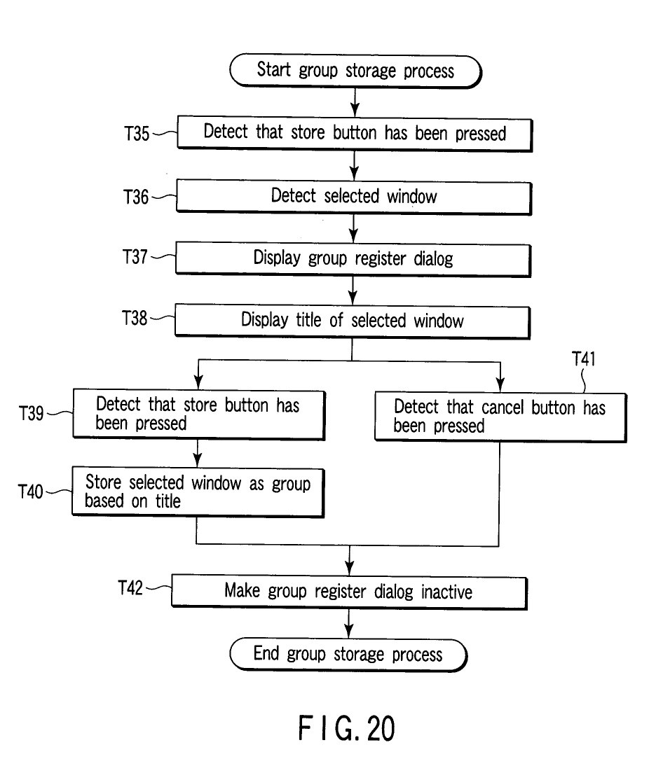

When the user presses the store button 28 after selecting an index display window 21, a group storage processing shown in FIG. 20 is executed in step S13.

When the processor unit 57 detects that the store button 28 has been pressed in step T35 shown in FIG. 20, the processor unit 57 specifies the selected index display window 21 in step T36. Subsequently, the group store dialog 35 is displayed in step T37, and a title of the selected index display window 21 is displayed in the input area 36 in step T38. Then, the apparatus waits until the user has made an operation.

When the user presses the store button 37, the processor unit 57 detects that the store button 37 has been pressed in step T39, and stores the management information while the index display window 21 whose title has been inputted in the input area 36 is handled as the same group. The group store dialog 35 is then cleared in step T42.

When the processor unit 57 detects that the cancel button 38 has been pressed in step T41, on the other hand, the group store dialog 35 is cleared in step T42.

Then, the group storage processing is terminated. Turning to FIG. 16, the apparatus waits a user's new operation and input.

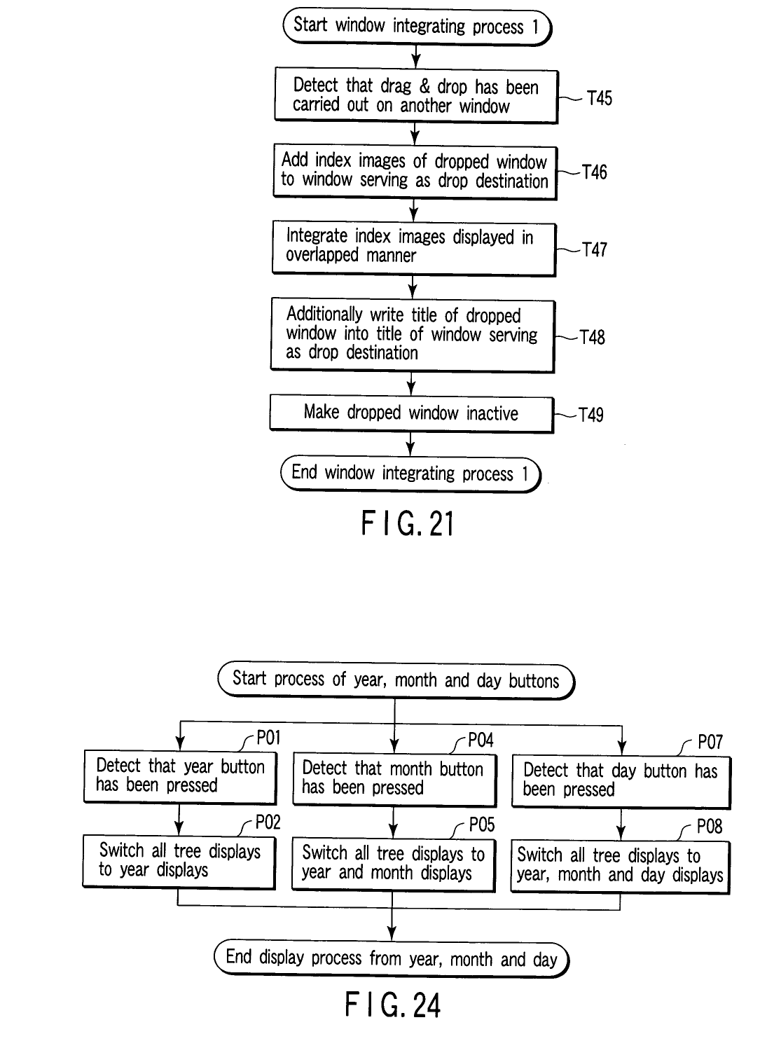

When the user has made a drag & drop operation on another index display window 21 after selecting one index display window 21, a window integrating process 1 shown in FIG. 21 is executed in step S14.

When, in step T45 shown in FIG. 21, the processor unit 57 detects that the index display window 21 has been dragged and dropped on another index display window 21, the processor unit 57 adds index images of the dropped index display window 21 to another index display window 21 serving as a drop destination in step T46.

In the case where there are two identical index windows 22 in step T47, these index images are integrated. In step T48, a title of the dropped index display window 21 is additionally written onto a title of another index display window 21 serving as a drop destination. Next, the dropped index display window 21 is cleared in step T49.

The window integrating process 1 is then terminated. Turning to FIG. 16, the apparatus waits for a user's new operation and input.

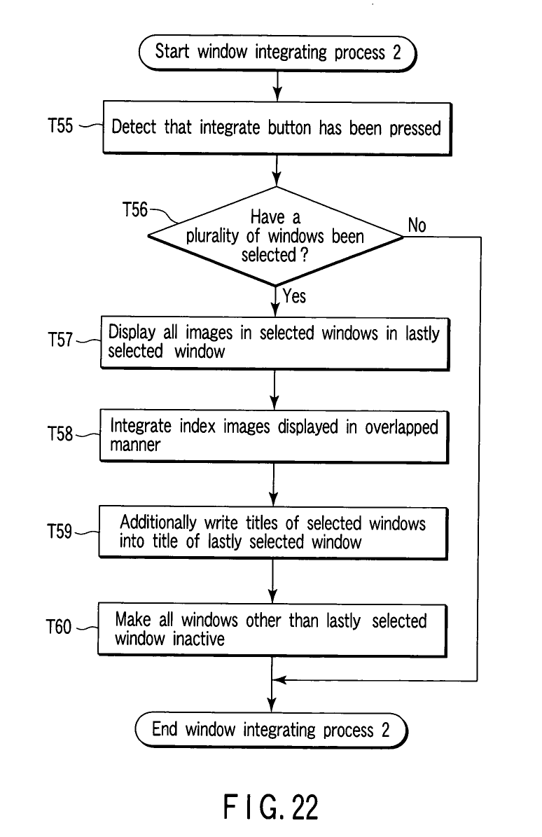

When the user presses the integrate button 29 after selecting a plurality of index display windows 21, a window integrating process 2 shown in FIG. 22 is executed in step S15.

When the processor unit 57 detects that the integrate button 29 has been pressed in step T55 shown in FIG. 22, the processor unit 57 checks whether or not the plurality of index display windows 21 have been selected in step T56.

In the case of Yes in step T56, i.e., in the case where the plurality of index display windows 21 have been selected, all index images of the other selected index display windows 21 are added to the lastly selected index display window 21.

In the case where there are a plurality of identical index images 22 in step T58, these index images are integrated. In step T59, titles of the other selected index display windows 21 are additionally written into a title of the lastly selected index display window 21. Next, in step T60, the index display windows 21 other than the lastly selected index display window 21 are cleared.

Then, the window integrating process 2 is terminated. Turning to FIG. 16, the apparatus waits for a user's new operation and input.

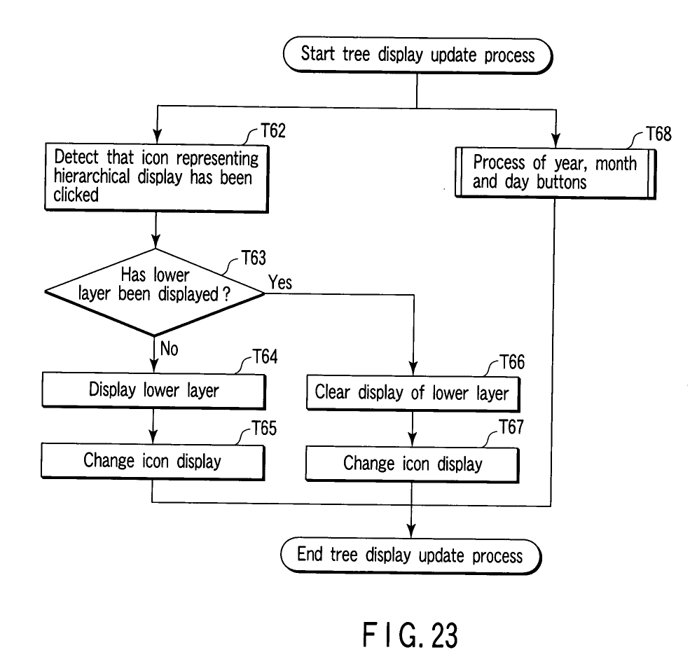

When the user clicks a hierarchical display icon in the time series tree display area 11, or presses the period specifying button 10 in the search condition input area 2, a tree display update processing shown in FIG. 23 is executed in step S16.

When the processor unit 57 detects that the user has clicked the hierarchical display icon in the time series tree display area 11 in step T62 shown in FIG. 23, it is checked that a lower layer of the hierarchical display icon has been displayed in step T63.

In the case of No in step T63, i.e., in the case where the lower layer is not displayed, the lower layer is displayed, and an icon display is changed in steps T64 and T65. In the case of Yes in step T63, i.e., in the case where the lower layer has been displayed, the display of the lower layer is cleared, and the icon display is changed in steps T66 and T67.

Then, the tree display update processing is terminated. Turning to FIG. 16, the apparatus waits for a user's new operation and input.

When the user presses the period specifying button 10 in the search condition input area 2, a processing of year, month and day buttons shown in FIG. 24 is executed in step T68 shown in FIG. 23.

When the processor unit 57 detects that the year button has been pressed in step P01 shown in FIG. 24, the processor unit 57 switches all the tree displays in the time series tree display area 11 to year displays in step P02.

When the processor unit 57 detects that the month button has been pressed in step P04, the processor unit 57 switches all the tree displays in the time series tree display area 11 to year displays in step P05.

When the processor unit 57 detects that the day button has been pressed in step P07, the processor unit 57 switches all the tree displays in the time series tree display area 11 to year, month and day displays in step P08.

Then, the processing of year, month and day buttons is terminated. Turning to FIG. 16, the apparatus waits for a user's new operation and input.

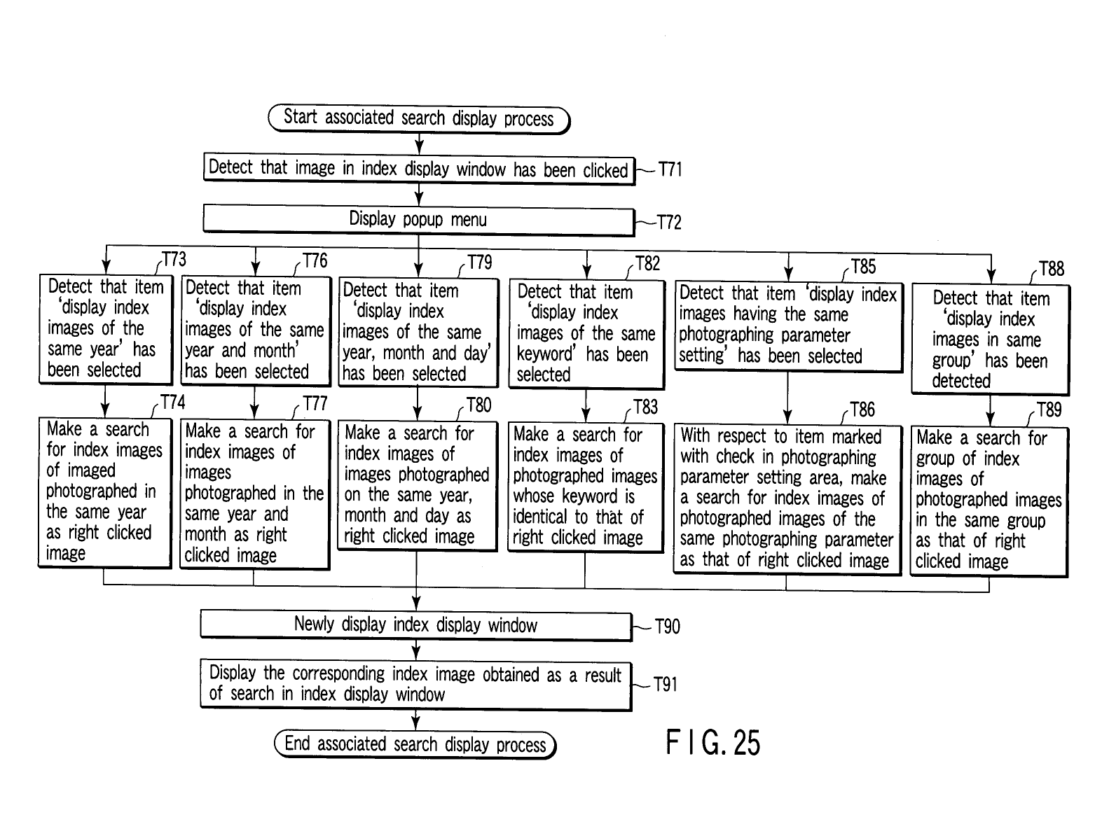

When the user clicks the right mouse button after pointing a mouse pointer onto the index image 22 in the index display window 21, an associated search display processing shown in FIG. 25 is executed in step S17.

When the processor unit 57 detects that the right button has been clicked on the index image 22 in the index display window 21 in step T71 shown in FIG. 25, the processor unit 57 displays a popup menu in step T72. Then, the apparatus waits until the user has selected an item from a menu.

When the processor unit 57 detects that an item “display index images of the same year” has been selected in step T73, the processor unit 57 makes a search for index images of images photographed in the same year as the right clicked index image, in step T74. Then, in steps T90 and T91, a new index display window 21 is displayed, and the corresponding index images obtained as a result of the search are displayed in the index display window 21.

When the processor unit 57 detects that an item “display index images of the same year and month” has been selected in step T76, the processor unit 57 makes a search for index images of images photographed in the same year and month as the right clicked index image, in step T77. Then, in steps T90 and T91, a new index display window 21 is displayed, and the corresponding index images obtained as a result of the search are displayed in the index display window 21.

When the processor unit 57 detects that an item “display index images of the same year, month and day” has been selected in step T79, the processor unit 57 makes a search for index images of images photographed on the same year, month and day as the right clicked index image, in step T80. Then, in steps T90 and T91, a new index display window 21 is displayed, and the corresponding index images obtained as a result of the search are displayed in the index display window 21.

When the processor unit 57 detects that an item “display index images of the same keyword” has been selected in step T82, the processor unit 57 makes a search for index images of photographed images whose keyword is identical to that of the right clicked index image, in step T83. Then, in steps T90 and T91, a new index display window 21 is displayed, and the corresponding index images obtained as a result of the search are displayed in the index display window 21.

When the processor unit 57 detects that an item “display index images having the same photographing parameter setting” has been selected in step T85, the processor unit 57 makes a search for index images of photographed images having the same photographing parameter as that of the right clicked index image, with respect to an item checked in the search target checkbox 12a in the photographing parameter setting area 12, in step T86. Then, in steps T90 and T91, a new index display window 21 is displayed, and the corresponding index images obtained as a result of the search are displayed in the index display window 21.

When the processor unit 57 detects that an item “display index images in the same group” has been selected in step T88, the processor unit 57 makes a search for index images of photographed images in the same group as that of the right clicked index image, in step T89. Then, in steps T90 and T91, a new index display window 21 is displayed, and the corresponding index images obtained as a result of the search are displayed in the index display window 21.

Then, the associated search display processing is terminated. Turning to FIG. 16, the apparatus waits for a user's new operation and input.

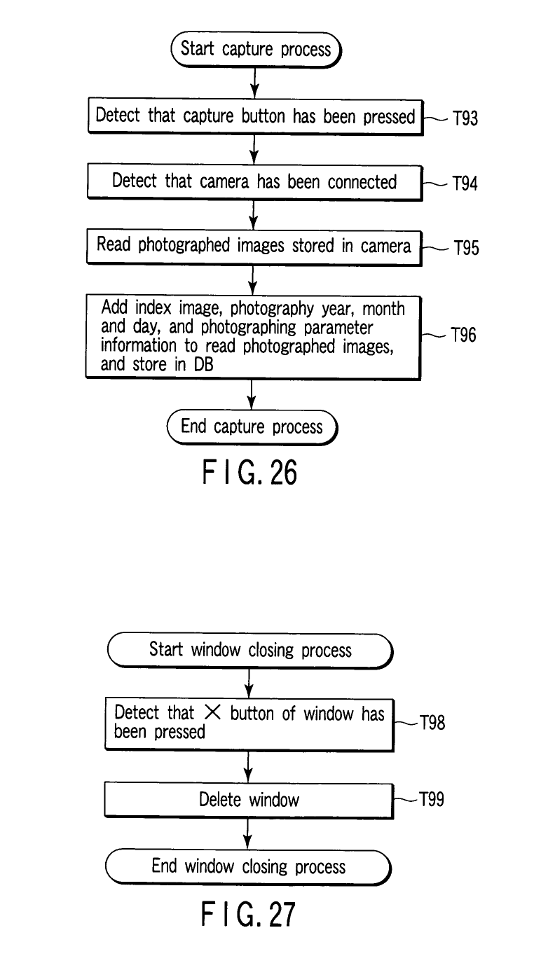

When the user presses the capture button 25 after a camera is connected to the image managing apparatus 50, a capture processing shown in FIG. 26 is executed in step S18.

When the processor unit 57 detects that the capture button 25 has been pressed in step T93 shown in FIG. 26, the processor unit 57 then detects that the camera has been connected in step T94.

When photographed images stored in the camera are read via the communication unit 53 in step T95, index images, year, month and day of photography, and photographing parameter information are added to the photographed images read, and management information is generated and the generated information is stored in the image DB 54 in step T96.

Then, the associated search display processing is terminated. Turning to FIG. 16, the apparatus waits for a user's new operation and input.

When the user presses an X button in an index display window 21, a processing for closing the window shown in FIG. 27 is executed in step S19.

When the processor unit 57 detects that the X button in the index display window 21 has been pressed in step T98 shown in FIG. 27, the processor unit 57 deletes that index display window 21 in step T99.

Then, the processing for closing the window is terminated. Turning to FIG. 16, the apparatus waits for a user's new operation and input.

When the user presses the exit button 30, the processor unit 57 detects that the exit button 30 has been pressed, and terminates the image management processing in step S20 shown in FIG. 16.

In the image managing apparatus according to the present embodiment, independent photographed image list windows can be opened by executing operations such as “specify year”, “specify year and month”, “specify year, month and day”, “specify keyword”, and “specify a plurality of arbitrary images, for example, specify selected images, year, month and day, and keyword”. Therefore, photographed images can be easily compared with one another.

There is no limitation to the number of windows that can be opened. In addition, windows can be displayed to be integrated with one another, and can be displayed to be grouped. Therefore, photographed images can be easily compared with one another and browsed.

Further, with respect to one index image displayed, independent image list windows can be opened by making a search for an image having the same year, month and day or keyword as that of the index image displayed. Therefore, a search can be easily made for images.

The functions described in the foregoing embodiment may be configured by using hardware components. Further, a program having described functions using software components may be achieved by computer reading. The above functions may also be configured by properly selecting either of the software and hardware components.

Moreover, the functions can be achieved by causing a computer to read a program stored in a storage medium, although not shown. Here, the storage mediums in the present embodiment may take any recording format as long as it can record a program and it is a computer readable storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image managing apparatus which searches and classifies images, the apparatus comprising:
an image memory which stores images;
a condition specifying unit which specifies at least one search condition;
a search unit which makes a search for images stored in the image memory under the search condition specified by the condition specifying unit;
a search result display unit which displays index images of the images searched by the search unit on one independent index display window;
a window selector unit which selects a plurality of displayed index display windows;
a window integrating unit which integrates the plurality of index display windows selected by the window selector unit into one index display window;
an index integrating unit which integrates and displays the index images displayed respectively in the plurality of selected index display windows in the one index display window integrated by the window integrating unit; and
a register unit which registers as one group, all images corresponding to the index images integrated into the one index display window by the index integrating unit.

2. An image managing apparatus according to claim 1, wherein the search condition specified by the condition specifying unit includes at least one of a photography date of an image, a keyword assigned to the image, and photography information assigned at the time of photography by a camera.

3. An image managing apparatus according to claim 2, wherein the search unit is configured to make a search for an image that belongs to a group registered by the register unit while a name for specifying the group is defined as a keyword.

4. An image managing apparatus according to claim 3, further comprising:
an index selector unit which selects an index image displayed in the index display window; and
a second search unit which makes a search for images that are identical in at least one of a photography date, a keyword, and photography information to an image that corresponds to the index image selected by the index selector unit,
wherein the search result display unit displays index images of the images searched by the second search unit in one independent index display window.

5. An image managing apparatus according to claim 1, wherein the index integrating unit carries out an integrating operation based on a union or an intersection of search conditions specified when a search is made for images that correspond to index images included in each of the windows integrated by the window integrating unit.

6. An image managing method for making a search for, and classifying images stored in an image memory, the method comprising:
a condition specifying step of specifying a search condition;
a search step of making a search for the images stored in the image memory under the search condition specified in the condition specifying step;
a search result display step of displaying index images of the images searched in the search step in one independent index display window;
a window selecting step of selecting a plurality of index display windows;
a window integrating step of integrating the plurality of index display windows selected in the window selecting step in one index display window;
an index integrating step of integrating and displaying the index images displayed respectively in the plurality of selected index display windows in the one index display window integrated in the window integrating step; and
a grouping step of registering as one group all images corresponding to the index images integrated in the one index display window in the index integrating step.

7. An image managing method according to claim 6, wherein the search condition specified in the condition specifying step includes at least one of a photography data of an image, a keyword assigned to the image, and photography information assigned at the time of photography by a camera.

8. An image managing method according to claim 7, wherein the search step enables to make a search for an image that belongs to a group registered in the grouping step while a name for specifying the group is defined as a keyword.

9. An image managing method according to claim 8, further comprising:
an index selecting step of selecting an index image displayed in the index display window; and
a second search step of making a search for images that are identical in at least one of a photography date, a keyword, and photography information to an image that corresponds to the index image selected in the index selecting step,
wherein the search result display step displays index images of the images searched in the second search step in one independent index display window.

10. An image managing method according to claim 6, wherein the index integrating step carries out an integrating operation based on a union or an intersection of search conditions specified when a search is made for images that correspond to index images included in each of the windows integrated in the window integrating step.

11. An image managing program for making a search for, and classifying images stored in an image memory, the program causing a computer to execute a process of:
specifying a search condition;
making a search for the images stored in the image memory under the specified search condition;
displaying index images of the searched images in one independent index display window;
selecting a plurality of the index display windows;
integrating the plurality of selected index display windows in one index display window;
integrating and displaying the index images displayed respectively in the plurality of selected index display windows in the one integrated index display window; and
registering as one group all images corresponding to the index images displayed in the one integrated index display window.

12. An image managing program according to claim 11, wherein the search condition specified includes at least one of a photography date of an image, a keyword assigned to the image, and photography information assigned at the time of photography by a camera.

13. An image managing program according to claim 12, wherein the search in accordance with the search condition enables to make a search for an image that belongs to the registered group while a name for specifying the group is defined as a keyword.

14. An image managing program according to claim 13, the program causing a computer to execute a process of:
selecting an index image displayed in the index display window;
further making a search for images that are identical in at least one of a photography date, a keyword, and photography information to an image that corresponds to the selected index image; and
displaying index images of the further searched images in one independent index display window.

15. An image managing program according to claim 11, wherein the index integration carries out an integrating operation based on a union or an intersection of search conditions specified when a search is made for images that correspond to index images included in each of the windows integrated.

16. A storage medium having recorded therein an image managing program for making a search for, and classifying images stored in an image memory, the program causing a computer to execute:
a condition specifying step of specifying a search condition;
a search step of making a search for the images stored in the image memory under the search condition specified in the condition specifying step;
a search result display step of displaying index images of the images searched in the search step in one independent index display window;
a window selecting step of selecting a plurality of index display windows;
a window integrating step of integrating the plurality of index display windows selected in the window selecting step in one index display window;
an index integrating step of integrating and displaying the index images displayed respectively in the plurality of selected index display windows in the one index display window integrated in the window integrating step; and
a grouping step of registering as one group all images corresponding to the index images integrated in the one index display window in the index integrating step.

17. A storage medium according to claim 16, wherein the search condition specified in the condition specifying step includes at least one of a photography date of an image, a keyword assigned to the image, and photography information assigned at the time of photography by a camera.

18. A storage medium according to claim 17, wherein the search step enables to make a search for an image that belongs to a group registered in the grouping step while a name for specifying the group is defined as a keyword.

19. A storage medium according to claim 18, the program further comprising:
an index selecting step of selecting an index image displayed in the index display window; and
a second search step of making a search for images that are identical in at least one of a photography date, a keyword, and photography information to an image that corresponds to the index image selected in the index selecting step,
wherein the search result display step displays index images of the images searched in the second search step in one independent index display window.

20. A storage medium according to claim 16, wherein the index integrating step carries out an integrating operation based on a union or an intersection of search conditions specified when a search is made for images that correspond to index images included in each of the windows integrated in the window integrating step.
